(19) United States
(12) Patent Application Publication
(10) Pub. No.: US 2004/0208439 A1
(43) Pub. Date: Oct. 21, 2004

(54) Method and apparatus for self-aligning photonic interconnections

(75) Inventors: John C. Bell, Crestwood, MO (US); Roger D. Chamberlain, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignees: BECS Technology, Inc.; Washington University, St. Louis, MO

(21) Appl. No.: 10/116,893

(22) Filed: Apr. 5, 2002

(51) Int. Cl. H04B 10/00

(52) U.S. Cl. 385/32

(57) ABSTRACT

A one-way communications pathway between two integrated circuits comprises a VCSEL array of one or more light emitters on a first integrated circuit, coupled to a photo-detector array on a second integrated circuit. The photo-detector array comprises a number of detectors which is greater than the number of activated light emitters, such that light from each emitter is imaged onto one or more detectors. Each detector generates an electrical current signal when illuminated by the emitter light. Individual electrical current signals from multiple illuminated detectors are selected via switches, and routed through a summing junction. The resulting summed signal is amplified and converted to a digital output signal.

### CROSS-REFERENCE TO RELATED APPLICATIONS

None.

### STATEMENT REGARDING FEDERALLY SPONSORED RESEARCH

Research for this application is supported in-part by DARPA under grant DAAL01-98-C-0074.

### BACKGROUND OF THE INVENTION

The present invention is related to the design of receiver circuits for use in self-aligning optical communications pathways, and more particularly, to a photonic receiver array wherein the number of detectors is greater than the number of light emitters, and which is dynamically configurable to identify one or more subsets of light receiving detectors usable for data reception.

A significant limiting factor in the design of current computer systems is the need for high-bandwidth, high-density chip-to-chip communication. While current electrical solutions, which include the use of high-speed parallel and serial communications, are likely to continue to improve, it is unlikely that any dramatic breakthroughs realizing orders of magnitude improvements in data delivery capacity are pending.

Optical or photonic technology, utilizing light, typically generated by lasers, to communicate information, provides unique opportunities for delivering high-bandwidth (>1 Gb/s per channel), high density (>1000 channels) inter-chip communications. One type of photonic technology typically utilizes two-dimensional arrays of Vertical Cavity Surface Emitting Lasers (VCSELs) as light emitters and a corresponding array of photo-detectors bonded to silicon as receivers. The VCSELs and photo-detectors are connected via free-space optics.

A problem encountered with optical or photonic technology is the requirement for active alignment between individual VCSELs and corresponding photo-detectors. Deviation from perfect alignment, wherein light from each individual VCSEL falls directly onto a corresponding photo-detector, is known as misalignment. In order for an illuminated photo-detector to produce an output signal of sufficient power for use in data communications, it must be sufficiently illuminated by the incoming light within a predetermined misalignment tolerance. Traditionally, the alignment of an optical channel is done manually. The laser is turned on, the signal from the receiver is monitored, and the physical positions of various components (i.e. laser, lenses, detectors, etc.) are altered until a sufficient signal is present at the output of the detectors.

One prior solution to the problem of misalignment between the emitters and the receivers in a photonic coupling is to use redundancy. For example, a system has been demonstrated using a 3×3 array of laser emitters and laser drivers, activated individually, to generate a single beam of laser light, which is received by a 3×3 array of detectors and receiver circuits having predetermined spacing. Activating a single laser emitter and driver circuit results in a single beam of light following a predetermined optical pathway from the emitter to the detector array. An optical lens is positioned over the detector array, to slightly defocus the beam upon arrival at the array, such that the diameter of the projected laser spot is significantly larger than the center-to-center spacing of adjacent detectors. This ensures that a projected laser spot will never fall into a “blind spot” between adjacent detectors. As such, within previously determined misalignment tolerances, there will always be an emitter and detector combination capable of transmitting and receiving sufficient optical power to transmit data.

Traditionally, before data can be transmitted over the optical channel, a controlled hunt algorithm tests all possible combinations of VCSELs and photo-detectors, i.e. channels, to determine which pair yields the highest received power level when the VCSEL is activated. For example, in a system having nine VCSELs and nine photo-detectors, there are a total of eighty-one possible communications channels.

In order to obtain the lowest bit error rate for a particular channel, the one with the highest optical power transfer must be selected. Testing is carried out by sequentially activating individual VCSELs and measuring the received power level at each individual photo-detector. The VCSEL and photo-detector pair having the highest received power level is recorded and utilized for further data transmission. Once the channel with the highest received power has been selected, the optical power received by that channel is continuously monitored. If the power level drops below a predetermined threshold, for example, due to subsequent misalignment between the emitters and receivers, the hunt algorithm immediately stops the transfer of data so that no data is lost, and initiates a new search for the best channel.

With a large closely packed array utilizing a complex switching circuit topology, it becomes impractical to illuminate all lasers simultaneously and concurrently measure the power levels detected by each switch settings, as it is unknown which laser is generating the observed light. Furthermore, it is impractical to test each laser independently, as the time required to do so is significant for large arrays (i.e. 1024 lasers in a 32×32 array).

Each detector generates an electrical current signal when illuminated by the projected laser spot. The electrical current signal is amplified through a single ended gain stage, i.e. a transimpedance amplifier (TIA), and routed to a pyramid switching network. The pyramid switching network is configured such that by activating selected analog switches, the amplified electrical signal from any one individual detector may be selected for power level monitoring and output as a digital logic signal.

Utilizing redundant circuits to generate and detect light beams in a photonic interconnection adds to component cost and required chip area. Additionally, the optical components utilized to expand the projected laser spot across multiple light detectors decrease the received power level of the light beam and require that the detectors be spaced apart to ensure that there will always be one detector upon receiving a majority portion of the incoming light, increasing the required chip area. Required chip area is further increased by the inclusion of one transimpedance amplifier for each detector.

Accordingly, there is a need for an improved photonic interconnection apparatus wherein the detector circuits occupy a minimum chip area, have a large misalignment tolerance, and do not require active alignment hunt algorithms.

### BRIEF SUMMARY OF THE INVENTION

Briefly stated, the present invention establishes a one-way communications pathway between two integrated circuits. The communications pathway comprises a VCSEL array of light emitters on a first integrated circuit, coupled via bulk optics or fiber image guides, to a photo-detector array on a second integrated circuit. The photo-detector array comprises a number of detectors which is greater than the number of activated light emitters, such that light from each emitter is imaged onto one or more detectors. Each detector generates an electrical current signal when illuminated by the emitter light. Individual electrical current signals from multiple illuminated detectors are selected via switches, and routed through a summing junction. The resulting summed signal is amplified and converted to a digital signal. The use of multiple detectors, i.e. subsets, to generate a summed output signal reduces the sensitivity of the communication pathway to mechanical misalignment between the emitters and detectors.

As a method, the present invention provides an algorithm to determine the alignment between the light emitters and light detectors in an optical communications pathway. To determine the alignment, the corner light emitters in an array are activated, and the received light power levels at the corresponding corner light detectors are observed, thereby determining the coordinates in the detector array of the illuminated spots. Using the two leftmost determined coordinates, a line is identified to determine the nominal laser spots in the leftmost column of active light detectors. The process is repeated for the rightmost active detectors to determine the nominal laser spots in the rightmost column of active light detectors. Continued calculation of straight lines yields nominal positions for each laser spot striking the detector array, permitting rapid determination of suitable light detector elements associated with each laser spot.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is simplified perspective view of a pair of electronic circuit chips linked via two one-way optical communications pathways of the present invention;

FIG. 2 is a simplified circuit diagram of a first embodiment of a light detector array circuit of the present invention;

FIG. 3 is a simplified circuit diagram of an alternate embodiment of a light detector array circuit of the present invention;

FIG. 4 is a simplified plan view of a light detector array illuminated by a pair of projected laser spots;

FIG. 5 is a simplified circuit diagram of the switching and amplification circuits associated with the light detector array shown in FIG. 4;

FIG. 6A is a simplified plan view of a 4×4 detector array having 9× redundancy;

FIG. 6B is a simplified circuit diagram of the switching and amplification circuits associated with the light detectors in a slice across the 4×4 detector array of FIG. 6A, taken at line 6B-6B;

FIG. 7 is an alternative circuit diagram of the switching and amplification circuits associated with a light detector array having additional peripheral edge detectors;

FIG. 8 is an alternative layout for circuit interconnections utilizing the one-way optical communications pathways of the present invention; and

FIG. 9 is an illustration of a closely packed array of light detectors and the illumination spots generated by an associated array of light emitters.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

For purposes of this specification, the following definition of the term “array” is provided. An array is a group of elements in regular order forming a complete unit. An array consisting only of elements arranged in a linear order, i.e. a single row or a single column, may be referred to as a linear array. An array consisting of elements arranged in multiple rows or columns may be referred to as a two-dimensional array. A linear array is a two-dimensional array having a height or width of one unit. Unless otherwise stated, the term “array” as used herein includes both linear and two-dimensional arrangements of elements. An array may also consist of only a single element, i.e. an array having a height of one unit and a width of one unit.

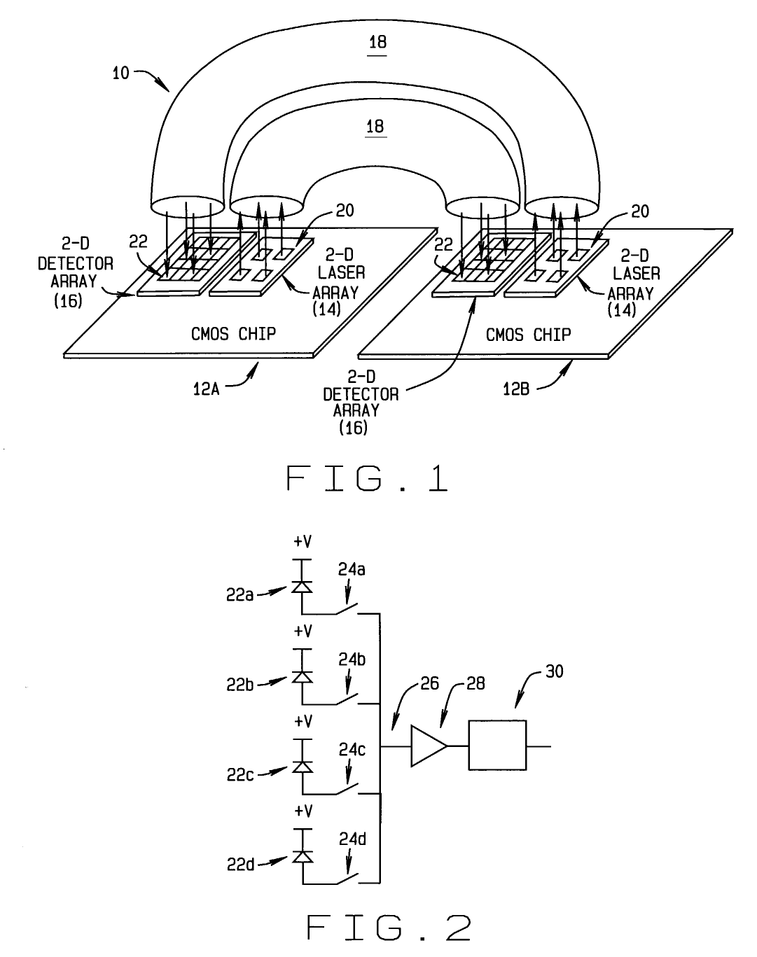

Turning to FIG. 1, a one-way optical communications pathway 10 of the present invention is shown between two electronic circuit chips 12A and 12B. The pathway 10 includes a light emitter array 14, shown as a two-dimensional array, a light detector array 16, shown as a two-dimensional array, and an optical pathway 18 linking the emitter array 14 with the detector array 16.

The light emitter array 14 consists of a set of light-emitting elements 20, preferably Vertical Cavity Surface Emitting Lasers (VCSELs), configured to transmit laser light vertically from the plane of the electronic circuit chip 12A or 12B. Each laser 20 is capable of providing data rates of at least 1 Gb/s. Arrays of size 32×32 can then provide an aggregate data rate of at least 1 Tb/s.

The optical pathway 18 carries light emitted by the light emitter array 14 to the light detector array 16. The optical pathway 18 may comprise free-space optics, or any light guiding components, such as bulk optics, i.e. lens and mirrors, or flexible fiber image guides. Flexible fiber image guides typically comprise a large number of individual optical fibers which are packed closely together with thin cladding layers. The individual optical fibers are selected such that an image spot of light projected from one of the light-emitting elements 20 is larger than the cross-sectional area of any individual optical fiber. Projected light from an individual light-emitting element 20 is accordingly carried through the flexible fiber image guide over a number of neighboring individual optical fibers. Since there is no requirement of one-to-one correspondence between individual light-emitting elements 20 and optical fibers in the flexible fiber image guide, alignment requirements between the flexible fiber image guide and the light emitter array 14 are reduced. Alignment requirements between the light emitter array 14 and the flexible fiber image guide merely require that the light emitting elements 20 located on the periphery of the light emitter array 14 project light into the flexible fiber image guide.

The light detector array 16 consists of a set of light detecting elements 22, preferably Metal-Semiconductor-Metal (MSM) photo-detectors, or photo diodes, each configured to produce an electrical current signal which is proportion to the level of light illumination received. As seen in FIG. 2, an output line from each light detecting element 22a-22d in a 2×2 light detector array 16 is routed through an associated switch 24a-24d, to a summing junction 26. An amplifier circuit 28, preferably a transimpedance amplifier (TIA), receives the summed electrical current signal from the summing junction 26 and routes the signal to power monitoring and receiver processing circuits 30 wherein it is converted to a digital logic signal.

By opening or closing switches 24a-24d associated with each light detecting element 22a-22d, electrical current signals from one or more light detecting elements 22, defining subsets within the light detector array 16, may be selected for summing and amplification. For example, in FIG. 2, opening and closing of switches 24a-24d can result in a summed and amplified output signal corresponding to any individual light detecting element 22a-22d, all light detecting elements 22a-22d, or any combination of two or three light detecting elements 22a-22d.

Those of ordinary skill in the art will recognize that the design shown in FIG. 2 may be modified to accommodate larger or smaller light detector arrays, for example, those comprising 1×n and j×k arrays of light detecting elements, where n, j, and k are any integer values. Correspondingly, it will be recognized that the number and arrangement of light-emitting elements 20 comprising the light emitting array 14 may be varied from 1 to n, where n is any integer value. For example, one possible alternative configuration includes only a single light-emitting element 20 in the light emitting array 14, and a linear array of four light detecting elements in the light detector array 16. Such configurations may be utilized in applications wherein mitigation of certain types of misalignment (e.g., off-axis orthogonal to the direction of the linear array of light detecting elements) is not a design concern.

Additionally, it will be recognized that the inclusion of additional switches 24 may be utilized to construct a pyramid switching network, wherein output signals, either amplified or un-amplified, from smaller subsets of a larger light detector array 16 may be routed to power monitoring and receiver processing circuits 30.

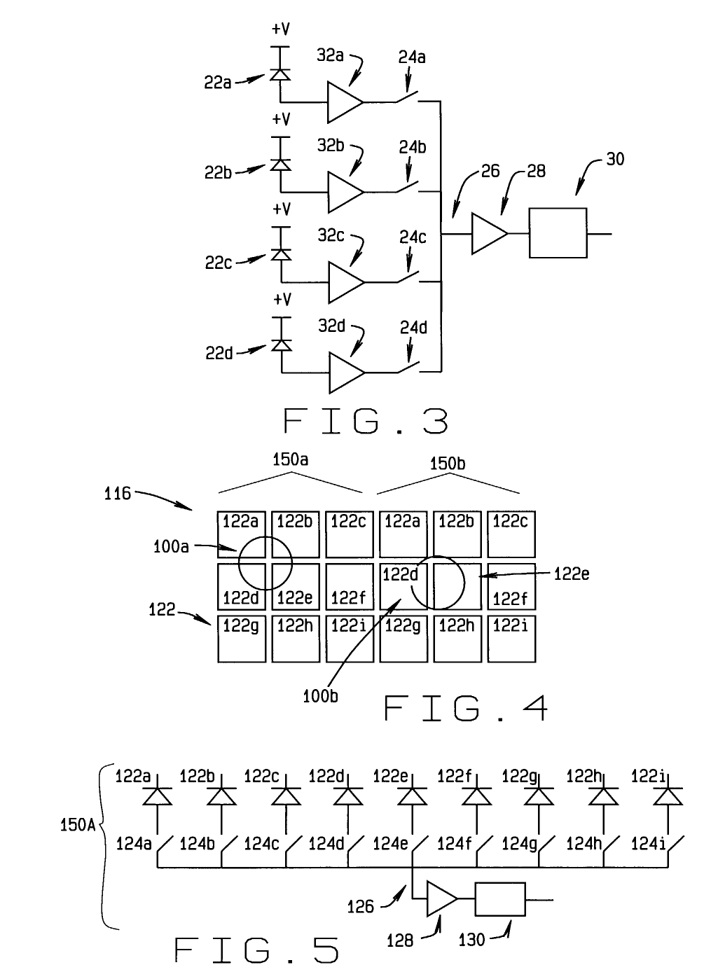

A further alternative design for the light detector array of FIG. 2 is shown in FIG. 3, with the addition of a current amplifier 32a-32d associated with each detector 22a-22d. The advantage of this alternate configuration is that the capacitive load associated with the first stage of amplification, i.e. trans-impedance amplifier 28 in FIG. 2 and current amplifiers 32a-32d in FIG. 3, is lower in FIG. 3 since multiple paths and the associated switches are not part of the load. In this configuration node 26 continues to act as a summing node, since the output of the current amplifiers 32a-32d is also a current signal. The disadvantage of this configuration is that it does have a greater chip area requirement when compared with the embodiment shown in FIG. 2, as it is required to implement the current amplifiers 32a-32d.

The self-alignment process, i.e. misalignment compensation, for the one-way optical communications pathway 10 of the present invention will be described in connection with FIGS. 4 and 5. Illustrated in FIG. 4 is a 3×6 light detector array 116, comprising eighteen individual light detecting elements 122, onto which two individual laser beams 100a and 100b are projected from a remote light emitter array (not shown). The switching and amplification circuits associated with the light detector array 116 shown in FIG. 4 are illustrated in FIG. 5. The light detector array 116 is subdivided into two 3×3, or 9× redundant, subsets 150a and 150b of light detecting elements 122. As shown in FIG. 5, the output lines from each of the nine light detecting elements 122a-122i comprising subset 150a are routed through corresponding switches 124a-124i, to a summing junction 126 and an amplifier circuit 128.

As can be seen in FIG. 4, laser beam 100a illuminates portions of light detecting elements 122a, 122b, 122d, and 122e in subset 150a, while laser beam 100b illuminates elements 122d and 122e in subset 150b. Accordingly, the output signals from each of these partially illuminated elements will be greater than those from non-illuminated elements. To maximize the output signal power, and therefore the data transfer rate from each subset, the output signals from individual light detecting elements 122 are routed to the power monitoring and receiving circuits 130. The power level of each signal is recorded. When all output signals from the individual light detecting elements 122 in a subset of the light detector array 116 have been recorded, the output signals from those light detecting elements 122 which exceed a predetermined threshold are routed to the summing junction 126 by closing the associated switches 124. The combined output signals from the summing junction 126 are then provided to the power monitoring and receiving circuits 130 for data transfer through amplifier 128. For example, as seen in FIG. 4, the output signals from light detecting elements 122a, 122b, 122d, and 122e in subset 150a are summed and provided to the power monitoring and receiving circuits 130, while the output signals from light detecting elements 122d and 122e in subset 150b are similarly summed and provided to the power monitoring and receiving circuits 130. This process is repeated for all laser beams in a light emitting array to establish subsets of light detecting elements which are associated with each individual beam.

Those of ordinary skill in the art will recognize that a variety of switching interconnections may be disposed between the individual light detecting elements and summing junctions associated with a light detector array, and between the summing junctions and amplifier circuits, so as to provide a highly configurable system.

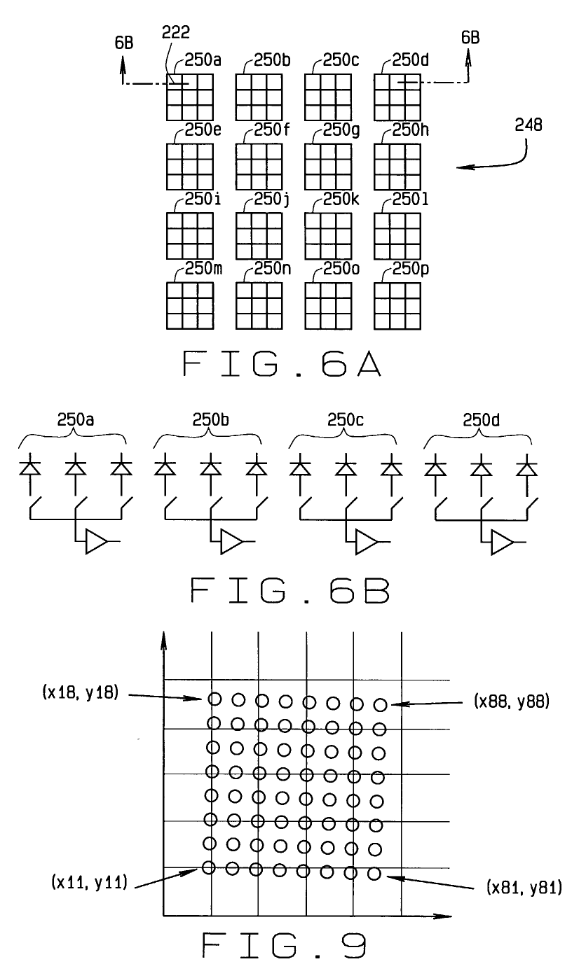

For example, an alternative configuration, shown in FIG. 6A would be to provide a 4×4 receiver array 248, wherein each of the 16 subsets 250a-250p of the receiver array 248 comprises a set of nine individual light detectors 222, arranged in a 3×3 grid, thereby providing a total of 144 individual light detectors. The output from each of the nine light detectors in each subset is routed to a summing junction associated with that subset, before being passed on to the power monitoring and receiving circuits. FIG. 6B illustrates a horizontal slice across a 4×4 receiver array such as shown in FIG. 6A, with each subset 250a-250p having 9× redundancy in light detectors. The circuit topology illustrated in FIG. 6B is the simplest circuit topology feasible, wherein light intended for the leftmost receiver must land on one or more of the leftmost three detectors.

FIG. 6A is shown with a gap between each subset of nine light detectors (e.g., between subset 250a and 250b as well as between subset 250a and 250e). It is also practical to design the system so that this gap does not exist, and the leftmost detectors of subset 250b are immediately adjacent the rightmost detectors of subset 250a.

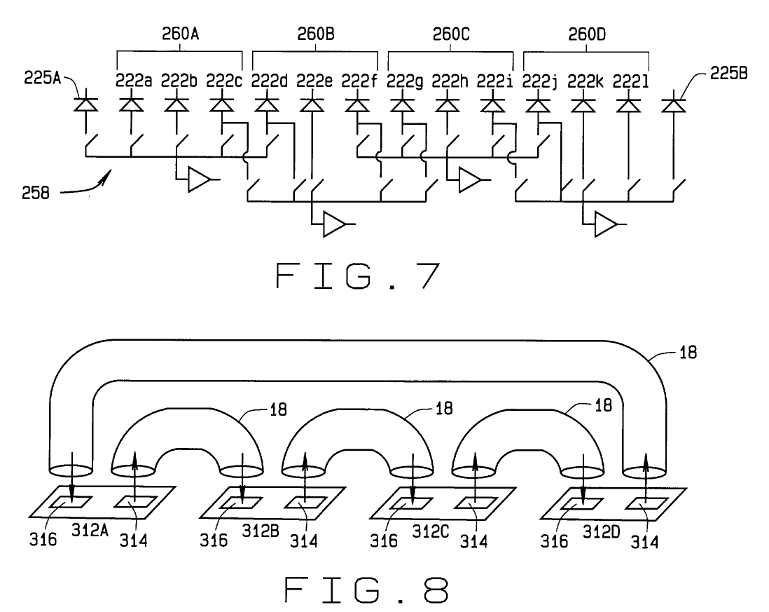

FIG. 7 represents an alternative circuit topology for a 4×4 receiver array 258 such as is shown in FIG. 6A, without the inter-subset gaps. In FIG. 7, a horizontal slice through the 4×4 receiver array is shown with four subsets 260A-260D, out of a total of sixteen subsets. Each subset provides 9× fundamental redundancy, however, additional light detectors 225A and 225B are added at either end of the slice to allow for additional misalignment tolerance at the periphery of the receiver array 258. In the circuit topology represented in FIG. 7, the boundary light detectors 222c, 222d, 222f, 222g, 222i, and 222j between each subset 260A-260D may be connected to either receiver circuit, permitting light intended for a subset of the receiver array to land on one of five detectors instead of only one of three light detectors. The switching topologies illustrated for a horizontal slice in FIGS. 6B and 7 are repeated in the orthogonal dimension, i.e. one can view FIGS. 6B and 7 as illustrating a vertical slice.

Those of ordinary skill in the art will further recognize that two of the one-way optical communications channels of the present invention may be may be utilized in conjunction to form a two-way optical communications channel wherein bi-directional data transfer is possible. For example, a two-way optical communications channel may be established between a processor circuit and a memory circuit, or a second processor circuit, by providing both light emitter arrays and light detector arrays on each circuit, and coupling corresponding emitter and detector arrays with suitable optical pathways. An alternative topology utilized to interconnect four processor circuits 312A-312D is illustrated in FIG. 8. As seen in FIG. 8, each processor circuit 312A-312D having a light emitter array 314 and light detector array 316 is linked via a one-way optical communications pathway 18 of the present invention with two adjacent processor circuits, thereby forming a ring topology.

Turning to FIG. 9, a method of the present invention for use in determining the initial alignment between a light emitter array and a light detector array, each having known configurations, is illustrated. With a large, closely packed array, and a switching topology of the style of FIG. 7, it is impractical to activate all of the individual light emitters 20 simultaneously and concurrently measure the power at each light detector 22 associated with all of the different switch settings, since it is unknown which light emitter 20 is generating the light power that is being measured. On the other hand, it is also impractical to activate each light emitter 20 sequentially, since the time required would get significant with large arrays of emitters (e.g., 1024 lasers in a 32×32 array).

It has been observed that misalignment between the light emitters 20 and the light detectors 22 does not vary the projected laser spot-to-spot spacing dimensions which correspond to the known array configuration. Rather, only the overall position of the entire array of projected laser spots varies as referenced to the array 16 of light detectors 22. This is illustrated in FIG. 9, which shows an 8×8 array of projected laser spots from a set of light emitters 20 on the surface of a light detector array, misaligned with a rotational error of 2 degrees.

Utilizing the known properties of the projected laser spot-to-spot dimensions, the following algorithm provides a rapid method for determining the initial switch settings for the two-dimensional array of light detectors 22 which will likely receive the highest power level. The initial alignment algorithm is as follows:

1. Illuminate the light emitters 20 at the corners of the emitter array.

2. Measure the power associated with the light detectors 22 upon which the corner emitters project their laser spots, thereby determining the coordinates (in the detector array) of the laser spots. For example, detectors: (x11,y11), (x81,y81), (x18,y18), and (x88,y88) as seen in FIG. 9.

3. Using the two leftmost determined coordinates (i.e., (x11,y11) and (x18,y18) in FIG. 9) formulate the equation for the straight line connecting these two points.

4. Use the formulated straight line to identify a nominal position of each projected laser spot in the leftmost column of light emitters 20.

5. Using the two rightmost known coordinates (i.e., (x81,y81) and (x88,y88) in FIG. 9) formulate the equation for the straight line that connects these two points.

6. Use this line to identify the nominal position of each projected laser spot in the rightmost column.

7. Using the nominal position of each projected laser spot at the end of each row, (i.e. left to right) formulate the equations for the straight lines connecting the two points at the end of each row. Use these lines to determine the nominal position of each spot in each row.

8. Illuminate all of the light emitters 20.

9. Using the identified nominal positions of each projected laser spot, measure the power associated with the light detectors 22 at or near each identified nominal position.

Since only the light detectors 22 within the array of light detectors that are near to the identified nominal positions of the projected laser spots will be designated as initial signal receivers and have their power measured, there is no opportunity in the method of the present invention for the power measurements to inadvertently measure power from an incorrect light emitter 20. Those of ordinary skill in the art will recognize that the specific sequence of steps set forth above for identifying initial switch settings for the array of light detectors 22 may be varied. For example, rather than finding the projected laser spot on the leftmost column (Steps 3 and 4), followed by the projected laser spot on the rightmost column (Steps 5 and 6), the sequence could be reversed. Correspondingly, the use of the leftmost and rightmost columns could be replaced by the use of the top and bottom rows, and the formulation of equations for rows replaced by the formulation of equations for columns of detectors.

Alternatively, the sequence of steps set forth above for identifying initial switch settings for the array of light detectors 22 may be altered for use with a one-dimensional or linear array of light detectors and emitters, i.e. a set of light detectors or emitters arranged along a line. Utilizing the known properties of the projected laser spot-to-spot dimensions, the following algorithm provides a rapid method for determining the initial switch settings for a one-dimensional or linear array of light detectors which will likely receive the highest power level. The one-dimensional or linear array alignment algorithm is as follows:

1. Illuminate the light emitters at the ends of the emitter array.

2. Measure the power associated with the light detectors 22 upon which the end emitters project their laser spots, thereby determining the coordinates (in the detector array) of the laser spots.

3. Using the determined coordinates which have the greatest separation, formulate an equation for the straight line connecting these two points.

4. Use the formulated straight line to identify a nominal position of each projected laser spot in the linear array of light emitters.

5. Illuminate all of the light emitters.

6. Using the identified nominal positions of each projected laser spot, measure the power associated with the light detectors at or near each identified nominal position.

Since only the light detectors within the linear array of light detectors that are near to the identified nominal positions of the projected laser spots will be designated as initial signal receivers and have their power measured, there is no opportunity in the method of the present invention for the power measurements to inadvertently measure power from an incorrect light emitter.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. An optical communications channel comprising:
at least one light emitting element, each light emitting element generating an illuminating light beam having a cross-sectional area;
a plurality of light detecting elements, each configured to generate an electrical signal when illuminated;
an optical pathway configured to guide light emitted by said at least one light emitting element to said plurality of light detecting elements; and
a switching network configured to selectively combine electrical signals from at least one of said plurality of light detecting elements to produce an output signal.

2. The optical communications channel of claim 1 wherein said at least one light emitting element comprises an array of vertical cavity surface emitting lasers.

3. The optical communications channel of claim 1 wherein said plurality of light detecting elements comprises an array of photo-detectors.

4. The optical communications channel of claim 1 wherein said plurality of light detecting elements comprises an array of photo diodes.

5. The optical communications channel of claim 1 wherein said optical pathway comprises a fiber image guide, said fiber image guide further comprising a plurality of individual fibers, each individual fiber within said fiber image guide having a cross-sectional area smaller than said cross-sectional area of a light beam emitted by said at least one light emitting element; and
wherein a light beam from said at least one light emitting elements is conveyed by two or more adjacent individual fibers to said plurality of light detecting elements.

6. The optical communications channel of claim 1 wherein said optical pathway comprises bulk optical elements.

7. The optical communications channel of claim 1 wherein said switching network comprises:
a signal amplifier disposed between said plurality of light detecting elements and an output line;
a summing junction disposed between said signal amplifier and said plurality of light detecting elements; and
a plurality of switches, each switch disposed between one of said plurality of light detecting elements and said summing junction;
wherein said plurality of switches are configured to route selected ones of said electrical signals from said plurality of light detecting elements through said summing junction and into said signal amplifier for transmission of an output signal on said output line.

8. The optical communications channel of claim 1 wherein said at least one light emitting element is associated with a processing circuit; and wherein said plurality of light detecting elements are associated with a memory circuit.

9. The optical communications channel of claim 1 wherein said at least one light emitting element is associated with a processing circuit; and wherein said plurality of light detecting elements are associated with a second processing circuit.

10. A bi-directional optical communications channel comprising a pair of optical communications channels of claim 1, wherein a first optical communications channel of said pair is disposed to communicate data from a first circuit to a second circuit, and wherein a second optical communications channel of said pair is disposed to communicate data from said second circuit to said first circuit.

11. The optical communications channel of claim 1 wherein said switching network comprises:
a signal amplifier disposed between said plurality of light detecting element and an output line;
a summing junction disposed between said signal amplifier and said plurality of light detecting elements;
a plurality of switches, each switch disposed between one of said plurality of light detecting elements and said summing junction;
a plurality of current amplifiers, each current amplifier disposed between one of said switches and one of said plurality of light detecting elements; and
wherein said plurality of switches are configured to route selected ones of said electrical signals from said plurality of light detecting elements through said summing junction and into said signal amplifier for transmission of an output signal on said output line.

12. An optical communications channel comprising:
at least one light emitting element, each of said at least one light emitting elements generating an illuminating light beam having a cross-sectional area;
a plurality of light detecting elements, each configured to generate an electrical signal when illuminated;
an optical pathway configured to guide light emitted by said at least one light emitting element to said plurality of light detecting elements; and
a switching network configured to selectively route an electrical signal from at least one of said plurality of light detecting elements to an amplifier circuit to produce an output signal.

13. A method for determining the initial alignment parameters in an optical communications channel having an array of light emitters in a known configuration coupled to an array of light detectors in a known configuration via an optical pathway, comprising:
activating a predetermined set of light emitters in said array;
identifying, at said array of light detectors, locations of light detectors receiving light from said corresponding activated set of light emitters;
utilizing said identified locations of light detectors receiving light from said corresponding activated set of light emitters, together with said known configuration of said light emitter array, to identify nominal positions within said array of light detectors upon which light emitted from the remaining light emitters in said array of light emitters will impact; and
designating a set of light detectors located at said identified locations from said array of light detectors as initial signal receivers.

14. The method of claim 13 for determining the initial alignment parameters in an optical communications channel wherein predetermined set of light emitters comprises light emitters located at the corners of said array of light emitters.

15. The method of claim 13 for determining the initial alignment parameters in an optical communications channel wherein said array of light emitters is a linear array, and wherein said predetermined set of light emitters comprises light emitters located at opposite ends of said linear array of light emitters.

16. The method of claim 13 for determining the initial alignment parameters in an optical communications channel wherein said array of light detectors is a linear array.

17. The method of claim 13 for determining the initial alignment parameters in an optical communications channel wherein the step of utilizing said identified locations of light detectors receiving light from said corresponding activated set of light emitters, together with said known configuration of said light emitter array, to identify nominal positions within said array of light detectors upon which light emitted from the remaining light emitters in said array of light emitters will impact includes the steps of
identifying light detectors within said light detector array which lie along lines between said light detectors receiving light; and
selecting light detectors from said identified light detectors which have positions nominally corresponding to positions of light emitters in said known configuration of said light emitter array, at an orientation defined by said lines.

18. A method for establishing an optical communications channel between a two-dimensional array of light emitters and a two-dimensional array of light detectors linked by an optical pathway, comprising:
sequentially activating individual light emitters in said two-dimensional array to project a beam of light through said optical pathway to said two-dimensional array of light detectors;
for each activation of an individual light emitter, summing the output signals from a plurality of subsets of light detectors in said array of light detectors; and
for each activation of an individual light emitter, identifying the subset of light detectors in said array of light detectors yielding the highest summed output signal.
